(19) United States
(12) Patent Application Publication
(10) Pub. No.: US 2014/0072463 A1
(43) Pub. Date: Mar. 13, 2014

(54) PUMP WITH DRY RUN PROTECTION

(71) Applicant: Herborner Pumpenfabrik J.H. Hoffmann GmbH & Co. KG, Herborn (DE)

(72) Inventors: Sascha KORUPP, Werdolf (DE); Lars RUNTE, Dillenburg-Frohnhausen (DE); Felix HEES, Giessen (DE)

(73) Assignee: Herborner Pumpenfabrik J.H. Hoffmann GmbH & Co. KG, Herborn (DE)

(21) Appl. No.: 14/021,093

(22) Filed: Sep. 9, 2013

(30) Foreign Application Priority Data
Sep. 7, 2012 (DE) 10 2012 108 358.4

(51) Int. Cl. F04D 29/10

(52) U.S. Cl. CPC F04D 29/106
USPC 417/423.11

(57) ABSTRACT

The invention relates to a pump, in particular a centrifugal pump (1), comprising a pump housing (2) with an inlet (3) and an outlet (4), wherein a motor shaft (11), which is connected in a rotationally fixed manner to an impeller (12) arranged in the pump housing (2), is rotatable mounted in a rear wall (5) of the pump housing (2) by means of a primary mechanical seal arrangement (14), wherein a dry run protection system is assigned to the primary mechanical seal arrangement (14).

In order to avoid downtimes and to keep maintenance costs low, the dry run protection system has a fluid volume (17) that is connected to a side of the primary mechanical seal arrangement (14), which side faces away from the impeller (12).

The invention relates to a pump, in particular a centrifugal pump according to the preamble of claim 1.

Such a pump comprises a pump housing with an inlet and an outlet, wherein a motor shaft, which is connected in a rotationally fixed manner to an impeller arranged in the pump housing, is rotatablv mounted in a rear wall of the music housing by means of a primary mechanical seal arrangement, wherein a dry run protection system is assigned to the primary mechanical seal arrangement.

Centrifugal pumps are in particular used for pumping liquid pump media such as, for example, swimming pool water. The pump medium is sucked in through the inlet and is dispensed under pressure through the outlet. For this purpose, an impeller is rotatably arranged in the pump housing of centrifugal pumps, which impeller Is connected to a motor via a motor shaft and is set into rotation by this motor. Thereby, a substantially radial flow is generated in the pump medium and, as a result, pressure is increased within the pump, and the pump medium is pushed out of the outlet.

Mounting the motor shaft in the pump housing or in the rear wall of the pump housing is usually carried out via a mechanical seal arrangement which comprises a mechanical sealing ring and a counter ring, wherein the mechanical sealing ring is connected stationarily in the pump housing, and the counter ring is connected stationarily to the motor shaft. During rotation of the motor shaft, the mechanical sealing ring and the counter ring then slide on each other. To increase tightness, an additional sealing ring can be provided between the mechanical sealing ring and the counter ring.

In order to keep friction losses low and to prevent that an additional temperature is exceeded, the mechanical seal arrangement has to be cooled or lubricated. Lubricating is usually carried out through the pump medium which wets the mechanical seal arrangement. Since an inside surface of the mechanical seal arrangement is usually connected with a pressure chamber of the pump, the pump medium can come into contact with the mechanical seal arrangement. It is also known to specifically lead the pressurized pump medium to the mechanical seal arrangement through special channels.

With this approach, dry running of the mechanical seal arrangement cannot be completely prevented. An air bubble forms around the mechanical seal arrangement and prevents the pump medium from cooling and lubricating between the mechanical sealing ring and the counter ring. This can result in overheating and finally in failure of the mechanical seal arrangement. The mechanical seal arrangement is then no longer capable of sufficiently sealing the pump housing. As a result, the pump medium can escape from the pressure chamber through the mechanical seal arrangement.

From DE 20 313 289 U1, a dry run protection system for a pump is known, wherein a filling level of the pump medium within the pump housing is monitored with a fluid detector. It is ensured here that operating the pump is only possible if the pump medium flows around the mechanical seal arrangement. For this purpose, an additional bypass channel is provided.

Such a dry run protection is a passive protection that works relatively reliably. However, upon detecting an error, the pump is always switched off, which can result in long downtimes and therefore entails increased maintenance costs. A complete stop of the pumps is problematic for many applications so that the range of use of such a dry run protection is limited.

It is now an object of the invention to eliminate the disadvantages of the prior art and in particular to provide a pump that has a high degree of operational reliability and requires little maintenance.

This object is achieved by a pump with the features of the claim 1. Configurations are subject matter of the claims 2 to 10.

The dry run protection system thus has a fluid volume that is connected with a side of the primary mechanical seal arrangement, which side faces away from the impeller. This can be achieved in that the fluid volume directly adjoins an outside of the primary mechanical seal arrangement. The fluid volume can be filled, for example, with white oil or another fluid. Lubricating and cooling the mechanical seal arrangement is carried out by this fluid in the event the lubrication through the pump medium is interrupted. Thereby, inadmissible heating of the mechanical seal arrangement is reliably prevented. This ensures that the mechanical sealing ring and the counter ring always slide on a thin film. Thus, active protection of the mechanical seal arrangement is provided by the dry run protection system, wherein an emergency lubrication is obtained so that failing lubrication of the primary mechanical seal arrangement by the pump medium does not have to cause switching off the pump. Rather, the primary mechanical seal arrangement is protected by the fluid in the fluid volume against temperature-induced failures. Moreover, in the case of a leak in the mechanical seal arrangement, the fluid volume prevents that pump medium can penetrate into the drive of the pump. Instead, the pump medium is then retained in the fluid volume. Thus, the dry run protection system reduces downtimes of the pump, and operational reliability is increased. Thereby, active protection is provided which allows continued operation of the pump also in cases of insufficient lubrication through the pump medium. Overall, this results in an extremely low-maintenance, reliable operation of the pump with a low failure probability.

Preferably, the fluid volume is formed between the rear wall of the pump and a cover of the pump housing. Thus, the fluid volume is formed by a chamber that is formed between the rear wall and the cover. If applicable, a modified standard rear wall can be used so as to provide a sufficient volume. The dry run protection system can then be implemented with relatively little effort.

It is particularly preferred here that the motor shaft is rotatably mounted in the cover by means of a secondary mechanical seal arrangement. This mechanical seal arrangement is then also cooled by the fluid in the fluid volume.

A particularly simple configuration is achieved in that the cover is connected to the rear wall in a fluid-tight manner, in particular is screwed or clamped thereto or pressed therein. If necessary, an additional sealing means can be provided between the cover and the rear wall so as to securely seal the fluid volume with respect to the outside. A screw connection between the cover and the rear wall has the advantage that the cover can be removed with relatively little effort so as to carry out maintenance work, for example.

In a preferred configuration, the dry run protection system has a reservoir that is connected to the fluid volume through an access that is formed in the pump housing, in particular in the rear wall. The reservoir is arranged outside of the pump housing and is connected to the access via lines, for example. The reservoir is used, on the one hand, for storing a sufficient amount of fluid so that a complete filling of the fluid volume is always ensured and, on the other, it is used as a pressure compensation container so that, for example, heating of the fluid in the fluid volume and resulting volume increase is not a problem.

It is particularly preferred that the reservoir is arranged geodetically higher than the primary mechanical seal arrangement. Thereby, on the one hand, automatic refilling of the fluid volume takes place and, on the other, it is ensured in this manner that the mechanical seal arrangement is always covered by the fluid in the fluid volume. An outlet of the reservoir should be formed on the reservoir at a position that is geodetically as low as possible so that all the fluid in the reservoir can be transferred into the fluid volume. In order to thereby enable a vertical and horizontal arrangement of the pump, the reservoir can be connected to the access, for example, via 90°-angled lines which exhibit sufficient mechanical stability so as to carry the reservoir. Thus, the overall construction is kept simple.

Preferably, a filling level of the reservoir can be monitored. When the fluid rises in the reservoir, a signal can then be output. Thus, a leak can be detected relatively quickly.

An advantageous configuration provides for this purpose that the reservoir is at least partially transparent. A fluid level in the reservoir is then relatively easily identifiable with the naked eye. Checking the dry run protection system is therefore possible with little effort. A transparent configuration of the reservoir is possible without any problems through a suitable material selection such as glass or plastics.

In order to improve the operational reliability it can be provided that the pump housing has an air bleeding device for bleeding a pressure chamber. The pressure chamber is usually located between the rear wall and the impeller. The air in the pressure chamber can causes malfunction of the lubrication of the mechanical seal arrangement by the pump medium. Accordingly, it is advantageous if the air can escape from the pump. For this purpose, the air bleeding device can comprise, for example, a bleed screw or a bleed valve that is manually or automatically operated.

In a preferred embodiment, the pump housing is made from gray iron. Thus, the pump can be produced in a very cost-effective manner. For use with corrosive fluids, the pump housing can have a corrosion-resistant coating so as to prevent corrosion of the pump housing.

Further features, details and advantages of the invention arise from the following description of exemplary embodiments based on the drawings in the figures:

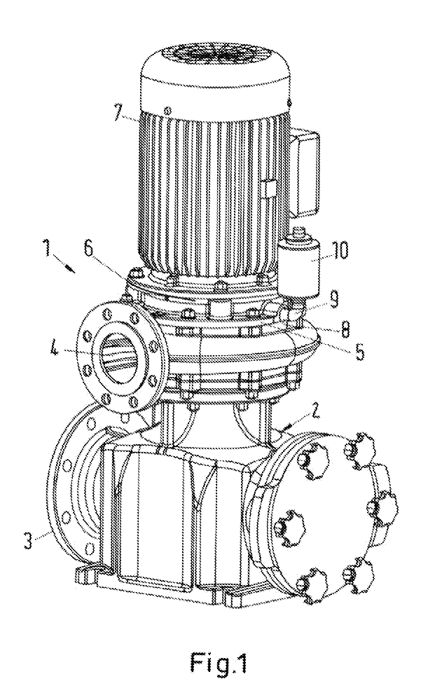

FIG. 1 shows a pump in a spatial illustration,

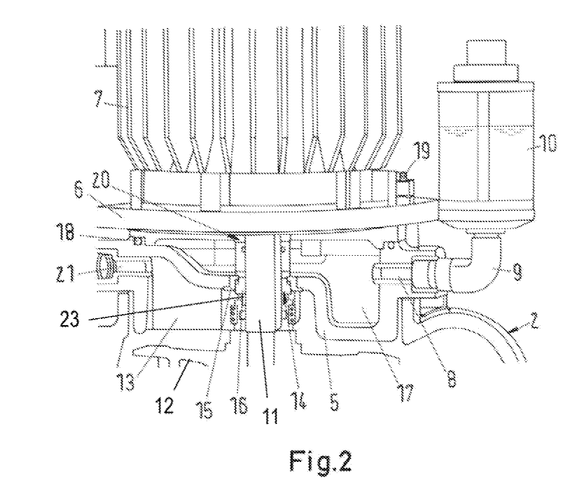

FIG. 2 shows a cut-out of the pump in a partial sectional view, and

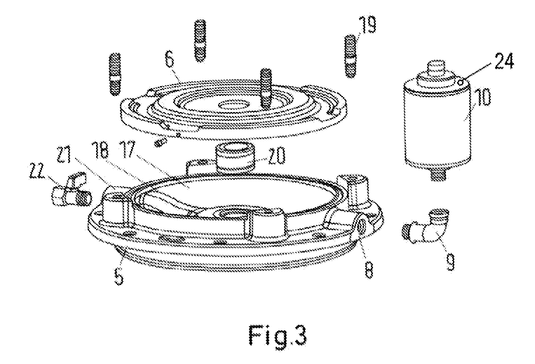

FIG. 3 shows components of a dry run protection system.

FIG. 1 shows a centrifugal pump 1 with a pump housing 2 in a spatial illustration. The pump housing 2 has an inlet 3 and an outlet 4 for a pump medium, in particular for fluids. The pump housing is a multi-piece design and comprises, among other things, a rear wall 5 that seals the pressure chamber, and a cover 6 that is fastened to the rear wall 5. A motor 7 that serves for driving an impeller is fixed on the cover 6.

A reservoir 10 is connected to the pressure chamber of the pump 1 via an access 8 and a line 9, wherein the access is formed as one piece with the rear wall 5. The reservoir 10 is formed from a transparent material such as glass so that the level of a fluid in the reservoir 10 is visible from the outside.

The reservoir 10 is part of the dry run protection system which is explained in more detail in connection with the FIG. 2 which shows a cut-out of a detail of the pump 1. The motor 7 is connected to an impeller 12 in a rotationally fixed manner via a motor shaft 11 and can set the impeller 12 into rotation. Thereby, a pump medium is acted on substantially in a radial direction so that a radial flow forms, and the pump medium is sucked in at the inlet 3 and is dispensed under pressure at the outlet 4. Accordingly, as pressure chamber 13 is located between the impeller 12 and the rear wall 5.

The motor shaft 11 is mounted in the rear wall 5 by means of a primary mechanical seal arrangement 14 that comprises at least one. mechanical sealing ring 15, 23 and one counter ring 16. The mechanical seal arrangement 14, on the one hand, serves for mounting the to shaft 11 in the rear wall 5 and, on the other, for sealing the pressure chamber 13. The pump medium contained in the pressure chamber 13 serves for lubricating the mechanical seal arrangement 14 so that normally a thin film from pump medium is formed between the mechanical sealing ring 15, 23 and the counter ring 16.

On one side of the rear wall 5, which side faces away from the pressure wall 13, a fluid volume 17 is formed in which a lubricating fluid such as, for example, white oil is received. The fluid volume 17 takes up space between the rear wall 5 and the cover 6 which, for this purpose, are connected to each other in a fluid-tight manner. For this, a seal 18 is arranged between the cover 6 and the rear wall 5, and the cover 6 is fastened by means of screws 19.

The motor shaft 11 is mounted in the cover 6 via a secondary mechanical seal arrangement 20. The secondary mechanical seal arrangement 20 seals the passage of the motor shaft 6 with respect to the fluid volume 17.

The fluid volume 17 should always be completely filled with fluid, if possible, so as to be in contact not only with the primary mechanical seal arrangement 14, but also with the secondary mechanical seal arrangement 20. The fluid volume 17 is connected via the access 8 to the reservoir 10 which is arranged geodetically higher than the primary mechanical seal arrangement 14 and the secondary mechanical seal arrangement 20, so that in particular as long as fluid is contained in the reservoir 10, it is always ensured that the primary mechanical seal arrangement 14 and the secondary mechanical seal arrangement 20 are covered by the fluid in the fluid volume 17. This ensures that the fluid volume 17 is automatically refilled from the reservoir 10. The reservoir 10 serves at the same time as a pressure compensation container which, for example, is able to compensate temperature-induced fluctuations of the fluid.

The fluid in the fluid volume 17 takes on a plurality of tasks. On the one hand, when the lubrication by the pump medium is interrupted, the fluid ensures sufficient cooling and lubrication of the primary mechanical seal arrangement 14. On the other hand, escaping of pump medium in the region of the mechanical seal arrangement 14 is prevented. Thus, the operational reliability of the pump is increased. In particular, dry running of the primary mechanical seal arrangement 14 is reliably avoided and continued operation of the pump is enabled even in cases where sufficient lubrication through the pump medium is not ensured. Lubricating and cooling of the secondary mechanical seal arrangement 20 can also be carried by the fluid in the fluid volume.

For bleeding the pressure chamber 13, a bleeding device 21 is provided in the pump housing 2, which bleeding device is arranged at the geodetically highest point of the pressure chamber 13 and enables manual bleeding of the pressure chamber 13.

FIG. 3 shows an exploded view of the substantial elements of the dry run protection system. In addition to the rear wall 5, which already exists in such pumps, the cover 6 is provided so as to be able to form the fluid volume 17 between the rear wall 5 and the cover 6. For this purpose, the rear wall 5 is additionally shaped so that a chamber of sufficient size for receiving the fluid is created. The cover 6 can be screwed to the rear 5 in a fluid-tight manner by means of the screws 19.

The motor shaft 11 is mounted in the cover 6 by means of a secondary mechanical seal arrangement 20.

In order to always ensure a sufficient filling level in the fluid volume 17, the fluid volume 17 is connected via the access 8 and the line 9 to the reservoir 10 from which fluid is automatically refilled. The reservoir can have an atmospheric connection 24, for example a hole. For bleeding the pressure chamber 13, a bleeding device 21 with a bleed screw 22 is provided in the rear wall 5. Thus, the dry run protection according the invention requires relatively few additional elements. At the same time, the dry run protection provides active safety and enables continued operation even if the lubrication through the pump medium is not sufficient. Rather, the primary mechanical seal arrangement is lubricated and cooled at the same time by fluid in the fluid volume so that it is protected against burns. In the event of a lack of pump medium at the primary mechanical seal, it is therefore not required to switch off the pump, nor is there the danger of damage to the primary mechanical seal. Rather, lubricating and cooling is carried out by the fluid in the fluid volume until sufficient pump medium is available on the pressure side. In this manner, the pump does not get damaged at all and the operation can be continued without failures. Thus, effective and active protection of the mechanical seal and therefore of the pump is provided.

Therefore, according to the invention, a pump is provided which offers high operational reliability while requiring little maintenance, and which is less susceptible to fault. At the same additional protection against leaking of pump media is obtained. If necessary, the pump housing can be provided with an additional coating, which makes particularly sense in cases where the pump housing is made of gray iron.

### REFERENCE LIST

1 Centrifugal pump

2 Pump housing

3 Inlet

4 Outlet

5 Rear wall

6 Cover

7 Motor

8 Access

9 Line

10 Reservoir

11 Motor shaft

12 Impeller

13 Pressure chamber

14 Primary mechanical seal arrangement

15 Mechanical sealing ring

16 Counter ring

17 Fluid volume

18 Seal

19 Screws

20 Secondary mechanical seal arrangement

21 Bleeding device

22 Bleed screw

23 Mechanical sealing ring

24 Atmospheric connection

1. A pump, in particular a centrifugal pump (1), comprising a pump housing (2) with an inlet (3) and an outlet (4), wherein a motor shaft (11), which is connected in a rotationally fixed manner to an impeller (12) arranged in the pump housing (2), is rotatably mounted in a rear wall (5) of the pump housing (2) by means of a primary mechanical seal arrangement (14), wherein a dry run protection system is assigned to the primary mechanical seat arrangement (14), characterized in that the dry run protection system has a fluid volume (17) that is connected to a side of the primary mechanical seal arrangement (14), which side faces away from the impeller (12).

2. The pump according to claim 1, characterized in that the fluid volume (17) is formed between the rear wall (5) and a cover (6) of the pump housing (2).

3. The pump according to claim 1, characterized in that the motor shaft (11) is rotatably mounted in the cover (6) by means of a secondary mechanical seal arrangement (20).

4. The pump according to claim 2, characterized in that the cover (6) is connected to the rear wall (5) in a fluid-tight manner, in particular is screwed or clamped thereto.

5. The pump according to claim 1, characterized in that the dry run protection system comprises a reservoir (10) that is connected to the fluid volume (17) through an access (8) that is formed in the pump housing (2), in particular in the rear wall (5) or in the cover (6).

6. The pump according to claim 5, characterized in that the reservoir (10) is arranged geodetically higher than the primary mechanical seal arrangement (14).

7. The pump according to claim 5, characterized in that a filling level of the reservoir (10) can be monitored.

8. The pump according to claim 5, characterized in that the reservoir (10) is at least partially transparent.

9. The pump according to claim 1, characterized in that the pump housing (2) has a bleeding device (21) for bleeding a pressure chamber (13).

10. The pump according to claim 1, characterized in that the pump housing (2) is made of gray iron and has in particular a coating.
